(19) United States
(12) Patent Application Publication
(10) Pub. No.: US 2010/0148516 A1
(43) Pub. Date: Jun. 17, 2010

(54) WIND POWERED GENERATOR

(76) Inventor: Barton A. Buhtz, Sunland, CA (US)

Correspondence Address: Richard Brewster Main, Esq., Patents Pending, 9832 Lois Stiltner Court, Elk Grove, CA, 95624, US

(21) Appl. No.: 12/709,456

(22) Filed: Feb. 20, 2010

Related U.S. Application Data
(63) Continuation-in-part of application No. 12/218,774, filed on Jul. 18, 2008.

(51) Int. Cl. F03D 3/04; H02K 21/24

(52) U.S. Cl. 290/55; 310/156.35

(57) ABSTRACT

A wind powered generator comprises a stationary tower to capture wind from any compass direction, an impeller inside the tower that is spun by wind entering through airfoil baffles on the outer walls of the tower, and a three-phase alternator that sandwiches and spins flywheels bejeweled with ceramic magnets in a stack between stator disks of pancaked windings.

### COPENDING APPLICATIONS

This Application is a Continuation-In-Part of U.S. patent application Ser. No. 12/218,774, filed Jul. 18, 2008, and titled, VERTICAL SHAFT, HORIZONTALLY DRIVEN, SHROUDED WIND/ELECTRIC SYSTEM, by the Present Inventor, Barton A. Buhtz. Such is incorporated herein by reference.

### BACKGROUND

1. Field of the Invention

The present invention relates to wind powered generators, and more particularly to stationary cylindrical towers with an outer system of airfoil baffles that directs and throttles wind from any compass direction into an inner impeller rotating on a vertical axle and bearings, and further relating to electrical alternators with magnets mounted on flywheel rotors stacked between stator disks of three-phase windings.

2. Description of the Prior Art

Renewable energy sources like wind and solar systems are developing into more significant and important parts of the national power grid. Solar systems obviously need good sunlight to operate at maximum efficiency, but wind powered generators only require wind and can operate day or night, overcast or sunny. Wind power systems are therefore an important and useful complement to solar energy systems.

Conventional wind generation systems, like those deployed in the thousands at Altamont Pass in the hills east of Livermore, Calif., depend on huge three bladed propellers that must be turned into the wind. But if the wind blows too hard, these propellers need to have their blades feathered so the moving parts don't spin too fast and destroy themselves. The generating machinery and electrical systems also need to be mounted 100-200 feet up in the air behind the axis of the propeller, and the whole must be able to turn into the wind. In spite of all these shortcomings, these conventional systems still earn their operators an income and the national power grid is supplied with substantial amounts of renewable emery and green energy credits.

What is needed is a wind powered generator that is more robust, more efficient, easier to operate, less costly to construct, simpler to maintain, and that nevertheless can generate serious amounts of electrical power.

### SUMMARY OF THE INVENTION

Briefly, a wind powered generator embodiment of the present invention comprises a stationary tower to capture wind from any compass direction, an impeller inside the tower that is spun by wind entering through airfoil baffles on the outer walls of the tower, and a three-phase alternator that sandwiches and spins flywheels bejeweled with ceramic magnets in a stack between stator disks of pancaked windings.

These and other objects and advantages of the present invention will no doubt become obvious to those of ordinary skill in the art after having read the following detailed description of the preferred embodiments which are illustrated in the various drawing figures.

### IN THE DRAWINGS

FIG. 1 is a perspective view diagram of a wind powered generator embodiment of the present invention;

FIG. 2 is a perspective view diagram of a simplified stationary vertical airfoil baffle shroud like that used in FIG. 1;

FIG. 3 is a top view diagram of a wind turbine like that used in FIG. 1;

FIG. 4 is a diagram representing how a wind turbine of the present invention admits wind energy and expels a spent airflow in a vortex exhaust at the top around the axis of rotation;

FIG. 5 is a perspective view diagram of an alternator embodiment of the present invention like that of FIG. 1;

FIG. 6 is a simplified perspective cutaway diagram showing the relationships between a magnetic flywheel and two adjacent stators, like those of FIG. 5; and

FIGS. 7A-7C represent one way to construct the field windings of FIG. 6, in a top view diagram of a stator winding, a top view diagram of three pickup coils in series, and a schematic diagram of the windings for the whole stator.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE PREFERRED EMBODIMENT

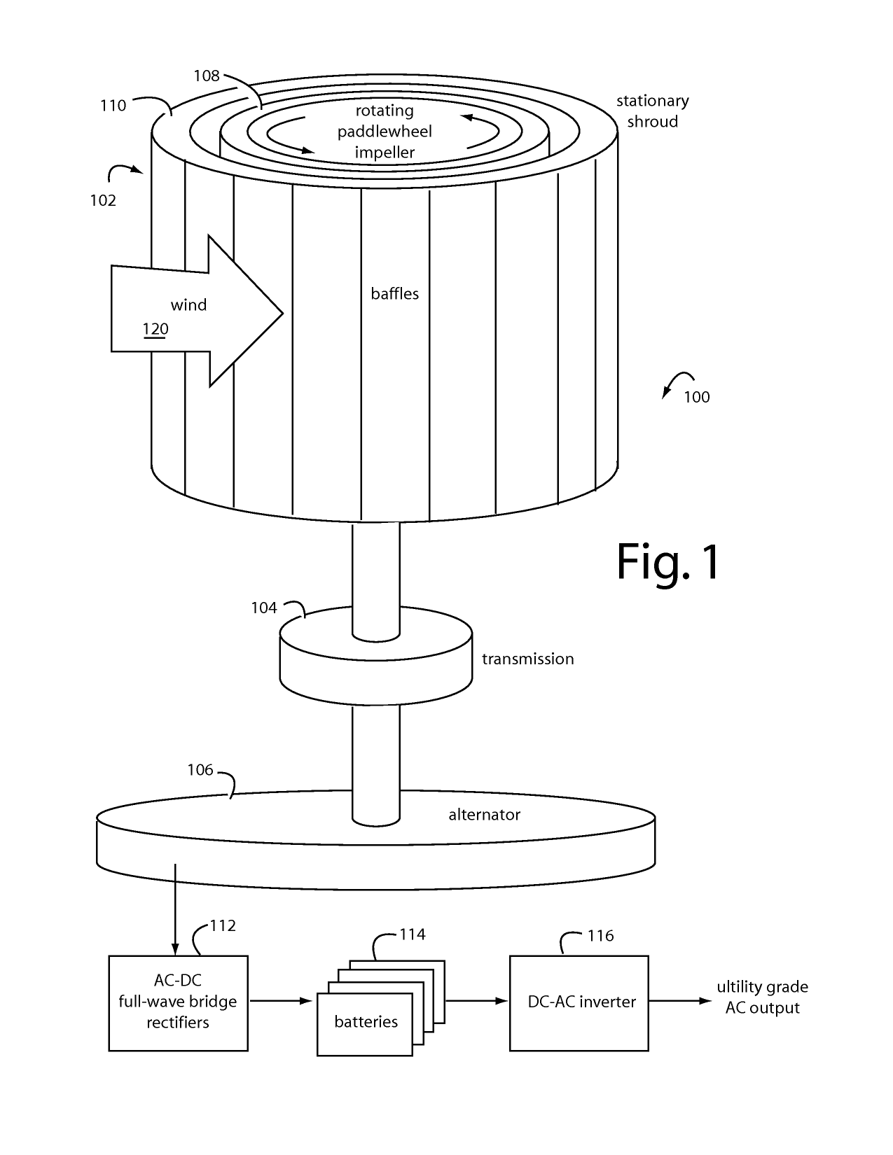

FIG. 1 represents a wind powered generator embodiment of the present invention, and is referred to herein by the general reference numeral 100. The wind powered generator 100 comprises a wind turbine 102 connected through a transmission 104 to an alternator 106. The output of alternator 106 is a high voltage alternating current (AC) that varies in frequency according to how fast an inner paddlewheel impeller 108 rotates inside a stationary vertical airfoil baffle shroud 110. The output frequency further depends on the coupling ratio of the transmission 104.

The AC output of the alternator 106 is converted to direct current (DC) by full-wave bridge rectifiers 112. The DC output will be on the order of hundreds of volts. High voltage AC and DC have power transmission advantages over low voltage systems because the currents are so much reduced for the same power levels and the same transmission line resistance.

The DC output of the full-wave bridge rectifiers 112 can be used to charge a battery bank 114. An inverter 116 converts the DC into utility grade 50-60 Hz AC at standard line or transmission grid voltages. For example, 220/440 VAC and 12K-16K VAC.

The stationary vertical airfoil baffle shroud 110 turns a wind 120 as it enters from any compass direction into a spinning vortex that can drive inner paddlewheel impeller 108. Spent wind is exhausted out the top along the central axis. The stationary vertical airfoil baffle shroud 110 also provides automatic throttling that will limit how much wind 120 can be accepted.

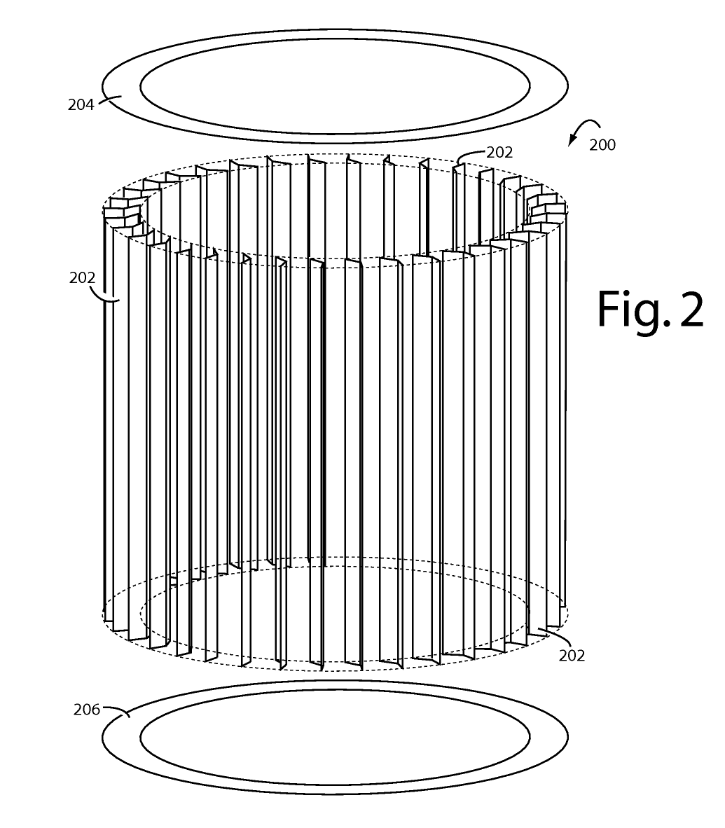

FIG. 2 represents a simplified stationary vertical airfoil baffle shroud 200, like that intended in FIG. 1. The stationary vertical airfoil baffle shroud 200 comprises a number of vertical slats 202 fixed between upper and lower mounting rings 204 and 206. Experiments have shown that a practical length for each slat 202 is about five feet. Each slat 202 is creased at least once lengthwise along its middle into a baffle that can turn the wind entering. The creases help stiffen each slat 202 and are principally responsible for being able to use five foot long pieces. Many tiers of stationary vertical airfoil baffle shrouds 200 can be assembled into stacks thirty feet high and ten feet in diameter. These are assembled at good sites with lots of wind, such as coastal mountain passes.

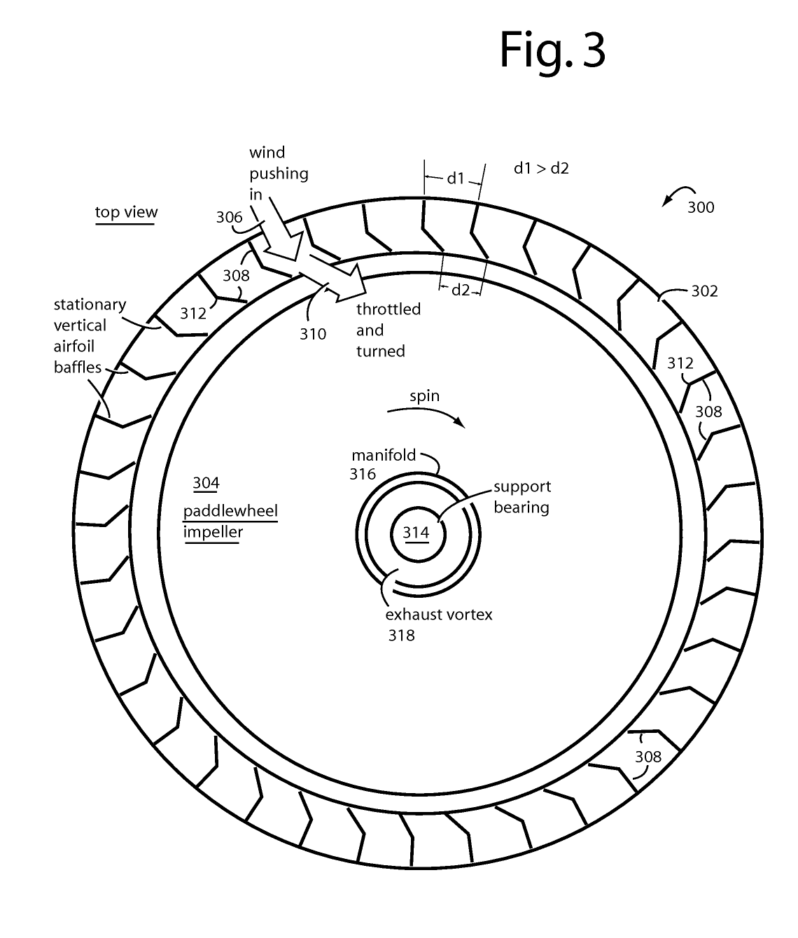

FIG. 3 looks down from the top of a wind turbine 300 which comprises a stationary vertical airfoil baffle shroud 302, like those of FIGS. 1 and 2. Inside, a paddlewheel impeller 304 is spun on a vertical axis by a wind 306 pushing in through airfoil baffles 308. This produces a throttled and turned airflow 310. The throttling occurs as a result of the outside openings (d1) between airfoil baffles 308 being greater than the inside openings (d2), e.g., d1>d2. The airfoil baffles 308 can be seen here to include at least one lengthwise crease 312 that provides for the turning of turned airflow 310. A central bearing support 314 is at the middle of a manifold 316 and an exhaust vortex 318.

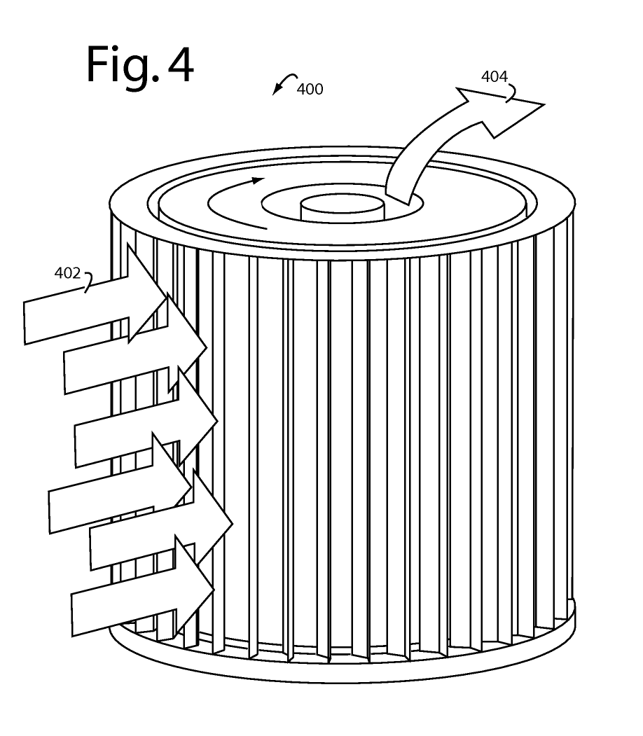

FIG. 4 represents how a wind turbine 400 of the present invention receives a wind 402 and expels it in a vortex exhaust 404 at the top around the axis of rotation.

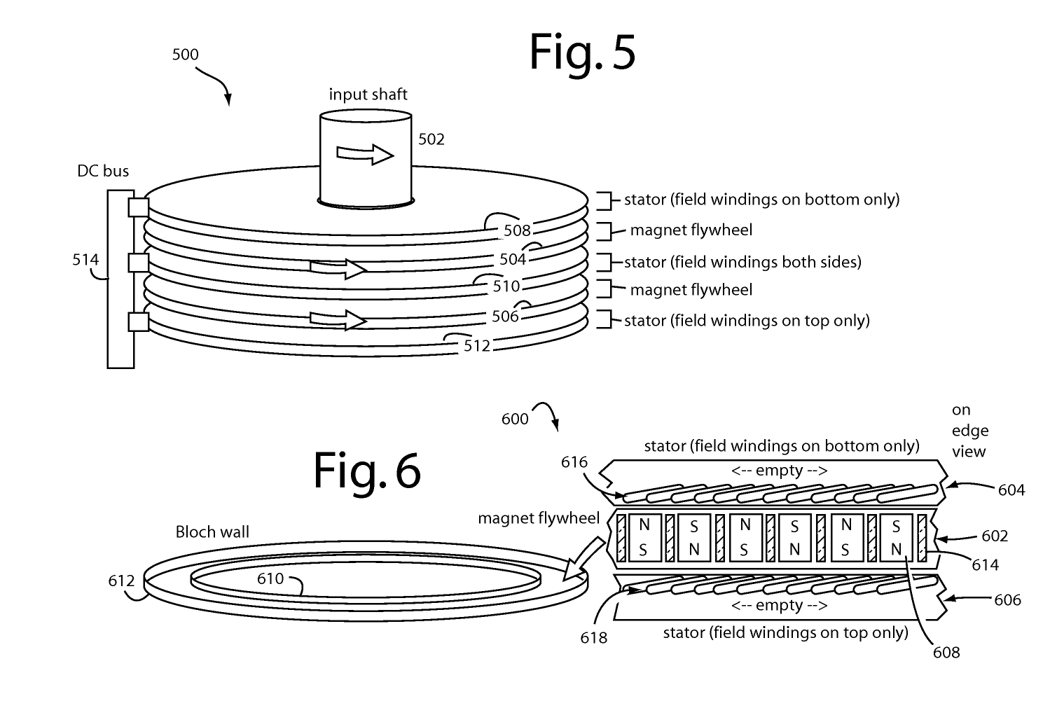

FIG. 5 represent an alternator 500 in an embodiment of the present invention, and could be used in the wind powered generator of FIG. 1. Alternator 500 has an input shaft 502 that turns, for example, two magnet flywheels 504 and 506 in a stack that includes stators 508, 510, and 512. More flywheels and corresponding stators are also possible, as is a single flywheel and stator.

Each stator 508, 510, and 512 includes field windings that cut through magnetic lines of force from individual magnets embedded in the two magnet flywheels 504 and 506 as they spin by in close proximity. Each stator 508, 510, and 512 has a top and bottom surface that can be independently fitted with three-phase field windings. The top and bottom surfaces are populated with field windings if the final assembly will have a match magnetic flywheel on that side. Otherwise it is left empty. The full-wave rectifiers, e.g., 112 of FIG. 1, can be included on each of stators 508, 510, and 512, such that their respective DC outputs can be bused together and collected across the stack of them. A DC bus 514 represents this alternative.

FIG. 6 shows the relationships between a magnetic flywheel 602 and two adjacent stators 604 and 606, like those of FIG. 5. Looking on edge, many permanent magnets 608 are arranged head-to-toe, near the outer perimeter of magnetic flywheel 602 between inner and outer aluminum ribbons 610 and 612. These help control and concentrate the magnetic lines of force emanating from the permanent magnets 608. Insulators 614 are disposed between permanent magnets 608 to guarantee the magnets do not touch one another. This creates a deliberate magnetic gap in the “core” that forces the magnetic lines of force to extend out further into adjacent stator field windings 616 and 618.

The pair of inner and outer concentric aluminum ribbons 610 and 614 are sheet metal configured and disposed in each flywheel such that corresponding said ceramic magnets that bejewel said outer perimeter surfaces of each the magnetic flywheel are curbed in a single file lane between.

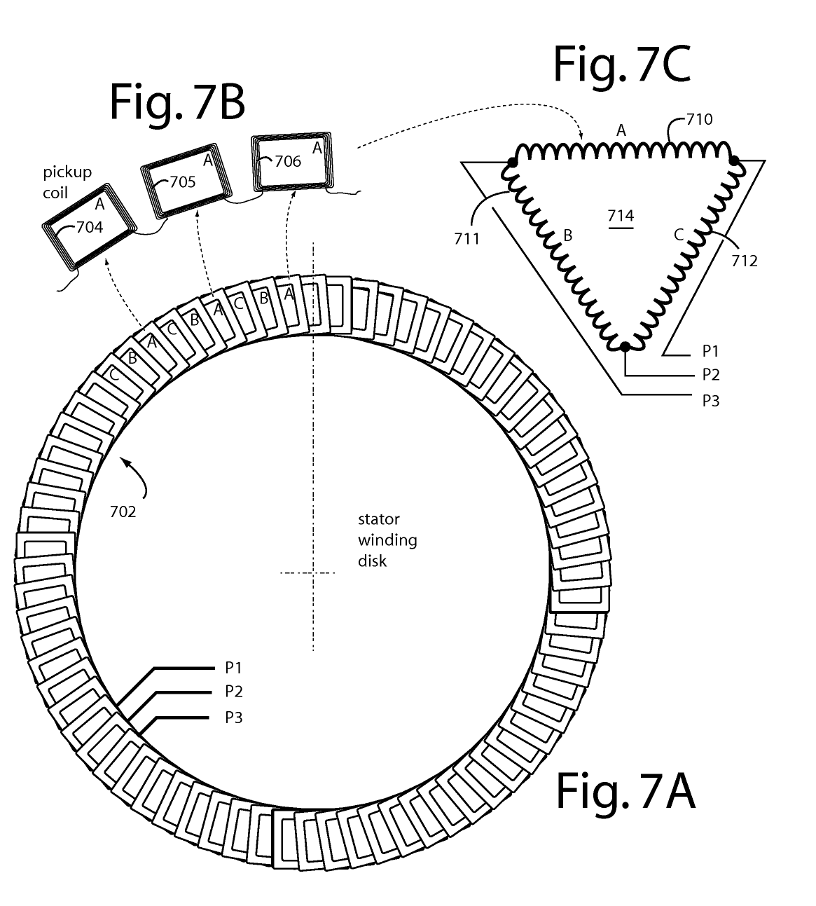

FIGS. 7A-7C represent one way to construct the field windings of FIG. 6. For a three-phase implementation, an array of pickup coils 702 is laid out in a circular ring with individual pickup coils, e.g., 704-706 of each phase A-B-C overlapping the next and then repeating in series in a constant diameter. Other polyphase arrangements are practical as well.

There is a matching permanent magnet embedded in the corresponding magnetic flywheel for each A-B-C set of pickup coils. This is such that each pickup coil will simultaneously experience the same magnetic rises and falls as its neighbors in the same phase A, B, or C, and the pickup coils' induced voltages will each peak, fall, and reverse in unison. In the example of FIG. 7B, there will be a set of three permanent magnets set at the same radial angles as the three pickup coils 704-706 and they will fly by along the coil middles. The three pickup coils 704-706 are shown as being pancaked, or flattened so that they can be interleaved and all laid as flat as possible.

A complete series connection of phase-A pickup coils is represented by an A-phase winding 710 in FIG. 7C. Similarly, a complete series connection of phase-B pickup coils is represented by a B-phase winding 711, and a complete series connection of phase-C pickup coils is represented by a C-phase winding 712. These are connected into a delta 714. A Y-configuration is also possible.

Although the present invention has been described in terms of the presently preferred embodiments, it is to be understood that the disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the “true” spirit and scope of the invention.

What is claimed is:

1. A wind powered generator, comprising:
a vertical, cylindrical stationary tower for capturing wind energy from any compass direction, and including an encircling grill wall of airfoil baffles;
an impeller mounted inside the tower that can be spun by wind energy pushing through said airfoil baffles like a vertical paddlewheel; and
a three-phase alternator that sandwiches and spins flywheels bejeweled with ceramic magnets in a stack between stator disks of pancaked windings.

2. The wind powered generator of claim 1, further comprising:
a mounting for said airfoil baffles that angles adjacent airfoil baffles to be set wider apart at their distal leading edges than at their inner trailing edges relative to a central, vertical axis of the stationary tower;
wherein, a self-throttling effect is produced that can automatically limit how much wind energy is admitted.

3. The wind powered generator of claim 1, further comprising:
at least one longitudinal crease along the length of each said airfoil baffle that both assists in turning wind being pushed in to spin the impeller, and that increases the end-to-end stiffness and rigidity of the airfoil baffle itself.

4. The wind powered generator of claim 1, further comprising:
paddle blades mounted to the impeller in a vertical paddlewheel arrangement around a central axle with bearings.

5. The wind powered generator of claim 4, further comprising:
a pair of longitudinal and parallel creases along the length of each said paddle blades that increase the end-to-end stiffness and rigidity of each paddle blade itself.

6. The wind powered generator of claim 1, further comprising:
a plurality of insulators and spacers set between adjacent and alternating head-to-toe arrangements of their respective north-south magnetic poles of said ceramic magnets that bejewel an outer perimeter surface of each said flywheel;
wherein, axially extending lines of magnetic force project further out by virtue of a gap created between adjacent ceramic magnets.

7. The wind powered generator of claim 1, further comprising:
a pair of inner and outer concentric ribbons of aluminum sheet metal configured and disposed in each flywheel such that corresponding said ceramic magnets that bejewel said outer perimeter surfaces of each said flywheel are curbed in a single file lane between.

10. A wind turbine, comprising:
an outer stationary shroud of parallel vertical slats creased lengthwise into airfoil baffles and providing for a throttling and turning of wind entering from any compass direction;
an inner rotating paddlewheel impeller on a vertical axis and configured to receive an airflow from said airfoil baffles; and
a central exhaust disposed along said central axis and for directing a spent vortex airflow out through the top;
wherein a wind coming from any compass direction is converted to a mechanical power output torque taken from the inner rotating paddlewheel impeller.

11. The wind turbine of claim 10, further comprising:
a mounting for said airfoil baffles that angles adjacent airfoil baffles to be set wider apart at their distal leading edges than at their inner trailing edges relative to a central, vertical axis of the stationary tower;
wherein, a self-throttling effect is produced that automatically limits how much wind energy can be admitted.

12. The wind turbine of claim 10, further comprising:
ay least one longitudinal crease along the length of each said airfoil baffle that both assists in turning wind being pushed in to spin the impeller, and that increases the end-to-end stiffness of the airfoil baffle itself.

13. The wind turbine of claim 10, further comprising:
paddle blades mounted to the impeller in a vertical paddlewheel arrangement around a central axle with bearings.

14. The wind turbine of claim 13, further comprising:
a pair of longitudinal and parallel creases along the length of each said paddle blades that increase the end-to-end stiffness of each paddle blade itself.

15. An electrical alternator, comprising:
a three-phase alternator that sandwiches and spins flywheels with ceramic magnets embedded near their outer perimeters in a stack between stator disks of windings;
wherein a mechanical power input torque is converted to an electrical output.

16. The electrical alternator of claim 15, further comprising:
a plurality of insulators and spacers set between adjacent and alternating head-to-toe arrangements of their respective north-south magnetic poles of said ceramic magnets;
wherein, axially extending lines of magnetic force project further out by virtue of a gap created between adjacent ceramic magnets.

17. The electrical alternator of claim 15, further comprising:
a pair of inner and outer concentric ribbons of aluminum sheet metal configured and disposed in each flywheel such that corresponding said ceramic magnets are curbed in a single file lane between.

18. The electrical alternator of claim 15, wherein:
a matching permanent magnet is embedded in the corresponding magnetic flywheel for each A-B-C set of pickup coils, such that each pickup coil will simultaneously experience the same magnetic rises and falls as its neighbors in the same phase A, B, or C, and the pickup coils' induced voltages will each peak, fall, and reverse in unison.

19. The electrical alternator of claim 15, wherein:
said stator disks of windings include pickup coils that are pancaked, or flattened so that they can be interleaved and all laid flat.
